(19) United States
(12) Patent Application Publication
(10) Pub. No.: US 2024/0388192 A1
(43) Pub. Date: Nov. 21, 2024

(54) CONTROL METHOD FOR A SWITCHING POWER SUPPLY AND A SWITCHING POWER SUPPLY

(71) Applicant: MIPTECH LIMITED, Central Hong Kong (CN)

(72) Inventor: Jun SHEN, Central Hong Kong (CN)

(21) Appl. No.: 18/696,304

(22) PCT Filed: Sep. 27, 2022
(86) PCT No.: PCT/CN2022/121692

§ 371 Date: Mar. 27, 2024

(30) Foreign Application Priority Data
Sep. 28, 2021 (CN) 202111143287.X

(51) Int. Cl. H02M 1/08; H02M 1/00; H02M 1/32; H02M 1/44; H02M 3/158

(52) U.S. Cl. CPC H02M 1/083; H02M 1/0038; H02M 1/0058; H02M 1/32; H02M 3/158; H02M 1/44

(57) ABSTRACT

Provided are a control method for a switching power supply and a switching power supply. The control method includes the following manners: After the switching power supply is started, a control module acquires the voltage waveform at the connection point between a first switching transistor and a filter inductor; while the voltage waveform at the connection point has not achieved zero-voltage switching, the control module adjusts the cut-off current of a second switching transistor until the voltage waveform at the connection point just reaches the high level; and when the voltage waveform at the connection point just reaches the high level, the control module controls the first switching transistor to turn on to achieve zero-voltage turn-on of the first switching transistor.

This application claims priority to Chinese Patent Application No. 202111143287.X filed with the China National Intellectual Property Administration (CNIPA) on Sep. 28, 2021, the disclosure of which is incorporated herein by reference in its entirety.

### TECHNICAL FIELD

Embodiments of the present application relate to the field of power supply technology, for example, a control method for a switching power supply and a switching power supply.

### BACKGROUND

In the power supply field, a non-isolated switching power supply has many advantages such as a simple circuit, low costs, and a low space requirement. The non-isolated switching power supply based on a basic architecture such as a buck architecture, a boost architecture, and a buck-boost architecture is widely used in providing power for an electrical device such as a mobile phone, a tablet, and a household appliance.

At present, in the related technologies, the non-isolated switching power supply based on a basic architecture has excessive switching losses, low efficiency, and a high level degree of electromagnetic interference (EMI). As a result, the increase of the power supply switching frequency is severely limited, and the miniaturization of the switching power supply is hindered. Based on the above, a non-isolated switching power supply that can implement zero voltage switch (ZVS) has emerged. However, compared with a non-isolated switching power supply of a basic architecture, a non-isolated switching power supply that can implement ZVS requires the addition of several key control loops and a corresponding hardware circuit structure. The circuit structure of a switching power supply based on a ZVS design idea tends to be complicated, which not only increases the hardware costs of the switching power supply, but also increases the control difficulty of the power supply.

### SUMMARY

Embodiments of the present application provide a control method for a switching power supply and a switching power supply to reduce the switching loss of the switching power supply and improve the EMI characteristic of the switching power supply without increasing hardware costs of the switching power supply.

In the first aspect, an embodiment of the present application provides a control method for a switching power supply. The switching power supply includes a first switching transistor, a second switching transistor, a filter inductor, and a control module. The first switching transistor is connected between a voltage input terminal and the filter inductor. The second switching transistor is connected between the first switching transistor and a ground terminal.

The filter inductor is connected between the first switching transistor and the voltage output terminal of the switching power supply. The control module is configured to control the first switching transistor and the second switching transistor to turn on or turn off.

The control method includes the steps below.

After the switching power supply is started, the control module acquires a voltage waveform at a connection point between the first switching transistor and the filter inductor.

While the voltage waveform at the connection point has not achieved zero-voltage switching, the control module adjusts the cut-off current of the second switching transistor until the voltage waveform at the connection point just reaches the high level.

When the voltage waveform at the connection point just reaches the high level, the control module controls the first switching transistor to turn on to achieve zero-voltage turn-on of the first switching transistor.

In the second aspect, an embodiment of the present application provides a switching power supply. The switching power supply includes a first switching transistor, a second switching transistor, a filter inductor, and a control module.

The first switching transistor is configured to be turned on or turned off according to a main drive signal generated by the control module.

The second switching transistor is configured to be turned on or turned off according to a synchronous drive signal generated by the control module.

The filter inductor is configured to smooth out an output current of the switching power supply.

The control module is configured to acquire a voltage waveform at a connection point between the first switching transistor and the filter inductor after the switching power supply is started. While the voltage waveform at the connection point has not achieved zero-voltage switching, the control module is also configured to adjust the cut-off current of the second switching transistor until the voltage waveform at the connection point just reaches the high level. When the voltage waveform at the connection point just reaches the high level, the control module is also configured to control the first switching transistor to turn on to achieve zero-voltage turn-on of the first switching transistor. When the load at the output terminal of the switching power supply changes, and the switching current of the first switching transistor is greater than a first preset value, the control module is also configured to adjust the peak current of the first switching transistor according to the output voltage of the switching power supply to achieve a loop control for stabilizing the output voltage of the switching power supply. After the loop control for stabilizing the output voltage of the switching power supply is achieved, when the load at the output terminal of the switching power supply changes, and the switching current of the first switching transistor is less than or equal to the first preset value, the control module is also configured to control the switching current of the first switching transistor to maintain at the first preset value, change the frequency of the drive signal of the first switching transistor, and enter a light-load ZVS mode from a heavy-load ZVS mode to adjust the output voltage of the switching power supply. After the control module entering the light-load ZVS mode to adjust the output voltage of the switching power supply, when the load at the output terminal of the switching power supply changes and the time interval between zero-crossing turn-off of the second switching transistor and next turn-on of the second switching transistor is equal to or less than a second preset value, the control module is also configured to enter the heavy-load ZVS mode again and adjust the peak current of the first switching transistor.

### BRIEF DESCRIPTION OF DRAWINGS

FIG. 1 is a diagram illustrating the structure of a switching power supply according to an embodiment of the present application.

FIG. 2 is a flowchart of a control method for a switching power supply according to an embodiment of the present application.

FIG. 3 is a flowchart of another control method for a switching power supply according to an embodiment of the present application.

FIG. 4 is a flowchart of another control method for a switching power supply according to an embodiment of the present application.

FIG. 5 is a flowchart of another control method for a switching power supply according to an embodiment of the present application.

FIG. 6 is a waveform diagram of a switching power supply in a heavy-load ZVS mode according to an embodiment of the present application.

FIG. 7 is a waveform diagram of a switching power supply in a light-load ZVS mode according to an embodiment of the present application.

FIG. 8 is a diagram illustrating the structure of another switching power supply according to an embodiment of the present application.

FIG. 9 is a waveform diagram of another switching power supply in a heavy-load ZVS mode according to an embodiment of the present application.

FIG. 10 is a waveform diagram of another switching power supply in a light-load ZVS mode according to an embodiment of the present application.

FIG. 11 is a diagram illustrating the structure of another switching power supply according to an embodiment of the present application.

### DETAILED DESCRIPTION

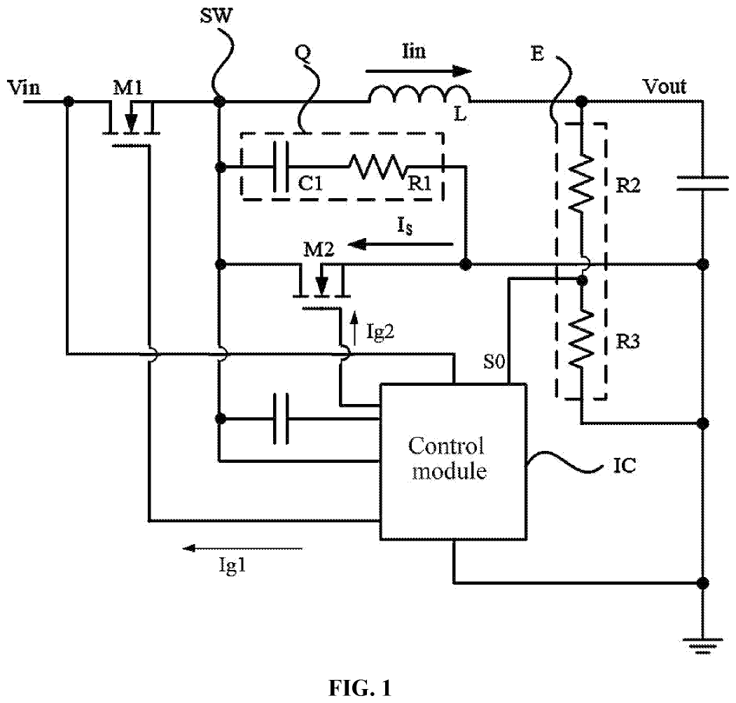

FIG. 1 is a diagram illustrating the structure of a switching power supply according to an embodiment of the present application. FIG. 2 is a flowchart of a control method for a switching power supply according to an embodiment of the present application. This embodiment of the present application is applicable to a power supply scenario of any device having a non-isolated synchronous switching power supply structure of a basic architecture such as a buck architecture, a boost architecture, and a buck-boost architecture. The control method for a switching power supply described in this embodiment of the present application may be, but is not limited to, executed by the switching power supply in this embodiment of the present application as the execution subject. The execution subject can be implemented using software and/or hardware. Non-isolated switching power supply includes non-isolated synchronous switching power supply. Although a non-isolated switching power supply is described in the present application, the control method for the switching power supply described in the present application is applicable to a non-isolated synchronous switching power supply.

FIG. 1 illustrates the structure of a non-isolated switching power supply with a buck architecture, and should not be considered as a limitation to the embodiment of the present application. With reference to FIG. 1, the switching power supply includes a first switching transistor M1, a second switching transistor M2, a filter inductor L, and a control module IC. The filter inductor L may also be used as an energy storage inductor. The first switching transistor M1 is connected between a voltage input terminal and the filter inductor L. The second switching transistor M2 is connected between the first switching transistor M1 and a ground terminal. The filter inductor L is connected between the first switching transistor M1 and the voltage output terminal of the switching power supply. The control module IC is configured to control the first switching transistor M1 and the second switching transistor M2 to turn on or turn off. As shown in FIG. 2, the control method includes the steps below.

In S110, after the switching power supply is started, the control module acquires a voltage waveform at a connection point between the first switching transistor and the filter inductor.

In S120, while the voltage waveform at the connection point has not achieved zero-voltage switching, the control module adjusts the cut-off current of the second switching transistor until the voltage waveform at the connection point just reaches the high level.

The cut-off current of the second switching transistor M2 refers to the turn-off current of the second switching transistor M2. For example, the voltage waveform at the connection point SW not achieving zero-voltage switching implies that the switching power supply has not achieved ZVS. In this case, the switching power supply experiences higher switching losses, lower efficiency and significant EMI.

The control module IC can adjust the cutoff current of the second switching transistor M2 in various ways, such as increasing, decreasing, increasing first and then decreasing, decreasing first and then increasing, or using any kind of oscillating adjustment process, It is to be understood that the preceding adjustment process of the cut-off current of the second switching transistor M2 may be adaptively adjusted based on the configuration and parameter selections of the switching power supply. This is not limited in this embodiment of the present application.

It is to be understood that the voltage waveform at the connection point SW just reaches the high level, which means that the voltage waveform at the connection point SW just reaches the high-level state of the input voltage Vin. In this case, the voltage difference between the source and the drain of the first switching transistor M1 is zero.

In S130, when the voltage waveform at the connection point just reaches the high level, the control module controls the first switching transistor to turn on to achieve zero-voltage turn-on of the first switching transistor.

The voltage waveform at the connection point SW just reaches the high level, which means that the switching power supply can implement ZVS right at this moment. Based on the above, in this embodiment of the present application, at the moment when the voltage waveform at the connection point SW just reaches the high level, the control module IC precisely controls the first switching transistor M1 to turn on, thereby achieving zero-voltage turn-on of the first switching transistor M1.

It is to be understood that since the switching power supply provided in this embodiment has a non-isolated switching power supply with a buck architecture, the first switching transistor M1 and the second switching transistor M2 cannot be turned on simultaneously. Thus, when the control module IC controls the first switching transistor M1 to turn on, the second switching transistor M2 is turned off.

For example, with continued reference to FIG. 1, it is to be understood that the turn-off process of the first switching transistor M1 is below.

The control module IC acquires the voltage difference between the source and the drain of the first switching transistor M1, that is, the difference between the input voltage and the voltage at the connection point SW. When the difference reaches a preset voltage reference value, the control module IC controls the first switching transistor M1 to turn off. It is to be understood that the preset voltage reference value corresponds to the peak current of the first switching transistor M1, that is, the peak current of the filter inductor L.

Embodiments of the present application provide a control method for a switching power supply and a switching power supply. The control method includes the following steps: After the switching power supply is started, the control module IC acquires the voltage waveform at the connection point SW between the first switching transistor M1 and the filter inductor L; while the voltage waveform at the connection point SW has not achieved zero-voltage switching, the control module IC adjusts the cut-off current of the second switching transistor M2 until the voltage waveform at the connection point SW just reaches the high level; and when the voltage waveform at the connection point SW just reaches the high level, the control module IC controls the first switching transistor M1 to turn on to achieve zero-voltage turn-on of the first switching transistor M1.

Compared with a non-isolated switching power supply with a basic architecture in the related technologies, the embodiments of the present application do not add an additional control loop and circuit structure and thus do not increase the circuit costs and control complexity of the switching power supply. In addition, in the related technologies, it is difficult for the control method of a non-isolated synchronous switching power supply with a basic architecture to implement ZVS, and the switching power supply experiences higher switching losses, lower efficiency and significant EMI. In the embodiments of the present application, while the voltage waveform at the connection point SW between the first switching transistor M1 and the filter inductor L has not achieved zero-voltage switching, the control module IC adjusts the cut-off current of the second switching transistor M2, and when the voltage waveform at the connection point SW just reaches the high level, the control module IC controls the first switching transistor M1 to turn on. Finally, ZVS of the switching power supply is achieved. In this manner, not only the switching loss of the switching power supply can be reduced, but also the EMI characteristic of the switching power supply can be improved.

Compared with a non-isolated switching power supply based on a ZVS design idea in the related technologies, the embodiments of the present application do not need to add an additional control loop and a corresponding hardware circuit. Thus, the circuit structure is simple, easy to control, and low in costs.

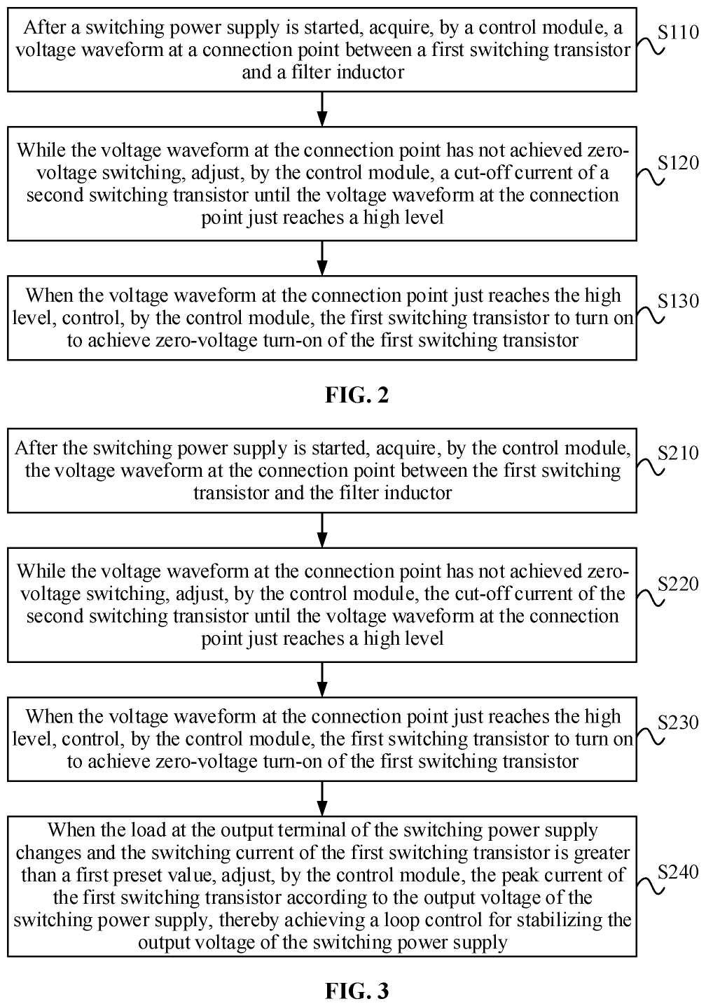

On the basis of the preceding embodiments, the adjustment method of the output voltage Vout of the switching power supply under a heavy load condition is described below. However, this is not limited in this embodiment of the present application. With continued reference to FIG. 1, the switching power supply also includes a voltage divider circuit E. The voltage divider circuit E is connected to the filter inductor L and the output voltage detection terminal S0 of the control module IC. FIG. 3 is a flowchart of another control method for a switching power supply according to an embodiment of the present application. As shown in FIG. 3, the control method for a switching power supply provided by this embodiment includes the steps below.

In S210, after the switching power supply is started, the control module acquires the voltage waveform at the connection point between the first switching transistor and the filter inductor.

In S220, while the voltage waveform at the connection point has not achieved zero-voltage switching, the control module adjusts the cut-off current of the second switching transistor until the voltage waveform at the connection point just reaches the high level.

In S230, when the voltage waveform at the connection point just reaches the high level, the control module controls the first switching transistor to turn on to achieve zero-voltage turn-on of the first switching transistor.

The zero-voltage turn-on state of the first switching transistor M1 may correspond to zero-voltage turn-on of the switching power supply. It is to be understood that in the process of adjusting the cut-off current of the second switching transistor M2, when the control module IC detects that the peak value of the voltage waveform at the connection point SW approximately reaches the high level, the control module IC controls the first switching transistor M1 to turn on to gradually implement zero-voltage turn-on of the switching power supply.

In S240, when the load at the output terminal of the switching power supply changes and the switching current of the first switching transistor is greater than a first preset value, the control module adjusts the peak current of the first switching transistor according to the output voltage of the switching power supply, thereby achieving a loop control for stabilizing the output voltage of the switching power supply.

The first preset value is a certain current value. The first preset value may be set as the initial setting of the switching power supply or may be independently set by a user. Here, the switching current of the first switching transistor refers to the current between the source and drain of the first switching transistor.

On the basis of implementing ZVS of the switching power supply in the preceding embodiment, this embodiment can achieve a loop control for stabilizing the output voltage Vout of the switching power supply when the switching power supply is in a heavy load state, and the load at the output terminal of the switching power supply changes, that is, the heavy-load ZVS mode of the switching power supply. Compared with the related technologies, the technical solutions of this embodiment reduce the switching losses of the switching power supply, and effectively improve the EMI characteristic of the switching power supply without increasing additional circuit costs and control complexity.

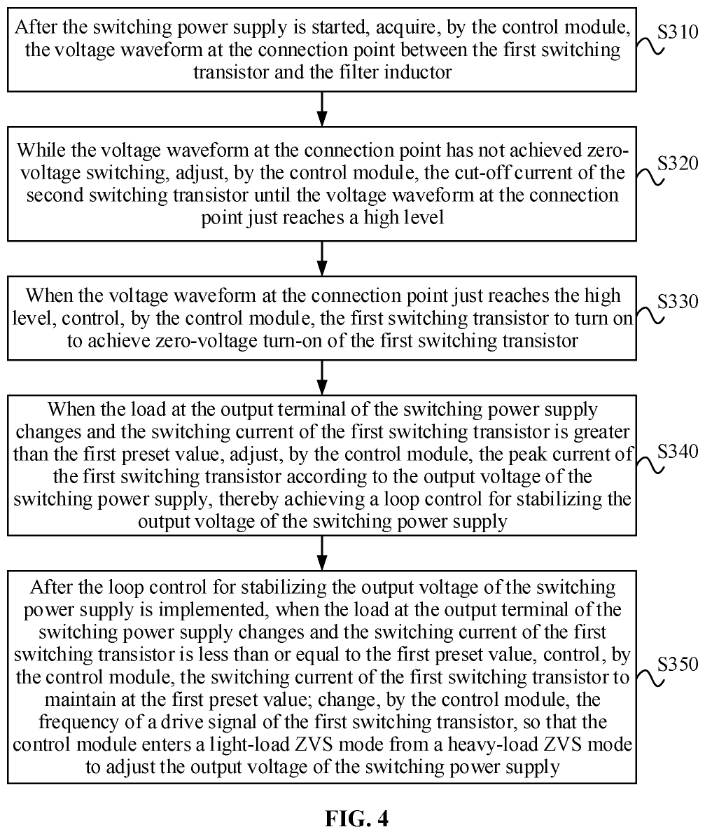

On the basis of the preceding embodiment, the control method for a switching power supply in the case where a heavy load is converted to a light load is described below. However, this is not limited in this embodiment of the present application. FIG. 4 is a flowchart of another control method for a switching power supply according to an embodiment of the present application. As shown in FIG. 4, the control method for a switching power supply provided by this embodiment includes the steps below.

In S310, after the switching power supply is started, the control module acquires the voltage waveform at the connection point between the first switching transistor and the filter inductor.

In S320, while the voltage waveform at the connection point has not achieved zero-voltage switching, the control module adjusts the cut-off current of the second switching transistor until the voltage waveform at the connection point just reaches the high level.

In S330, when the voltage waveform at the connection point just reaches the high level, the control module controls the first switching transistor to turn on to achieve zero-voltage turn-on of the first switching transistor.

In S340, when the load at the output terminal of the switching power supply changes and the switching current of the first switching transistor is greater than the first preset value, the control module adjusts the peak current of the first switching transistor according to the output voltage of the switching power supply, thereby achieving a loop control for stabilizing the output voltage of the switching power supply.

In S350, after the loop control for stabilizing the output voltage of the switching power supply is implemented, when the load at the output terminal of the switching power supply changes and the switching current of the first switching transistor is less than or equal to the first preset value, the control module controls the switching current of the first switching transistor to maintain at the first preset value, changes the frequency of the drive signal of the first switching transistor so that the control module enters a light-load ZVS mode from a heavy-load ZVS mode to adjust the output voltage of the switching power supply.

The drive signal of the first switching transistor is configured for controlling the first switching transistor M1 to turn on or turn off. For example, the drive signal may be a modulated signal of any pulse width or frequency.

It is to be understood that the fact that the load at the output terminal of the switching power supply changes and the switching current of the first switching transistor M1 is less than or equal to the first preset value means that since the load at the output terminal changes, the switching power supply is converted from a heavy load state to a light load state.

Based on the above, when the switching power supply is converted to the light load state, the control module IC enables the switching current of the first switching transistor M1 to maintain at the first preset value. The frequency of the drive signal of the first switching transistor M1 is changed to adjust the output voltage Vout of the switching power supply, that is, the efficiency of the switching power supply is optimized through frequency adjustment.

For example, S350 may be implemented in the manners below.

When the load at the output terminal of the switching power supply changes and the switching current of the first switching transistor M1 is less than or equal to the first preset value, the control module IC enables the switching current of the first switching transistor M1 to maintain near the first preset value based on an appropriate anti-jitter threshold value, thereby controlling the peak current of the first switching transistor M1 to be in a steady state. Then, the control module IC adaptively changes the time interval between turn-ons of the first switching transistor M1, so as to adjust the output voltage Vout of the switching power supply in a light-load ZVS mode through frequency adjustment.

In summary, on the basis that ZVS of the switching power supply in the heavy load state is achieved in the preceding embodiment, and the output voltage Vout of the switching power supply is maintained in a steady state, when the switching power supply converts from the heavy load state to the light load state, in this embodiment, the efficiency of the switching power supply in the light-load ZVS mode is optimized through frequency adjustment. Compared with the related technologies, the technical solutions of this embodiment can achieve real-time conversion between the light-load ZVS mode and the heavy-load ZVS mode according to the load change at the output terminal of the switching power supply without increasing additional circuit costs and control complexity. In this manner, not only the switching loss of the switching power supply is effectively reduced, but also the EMI characteristic of the switching power supply is improved.

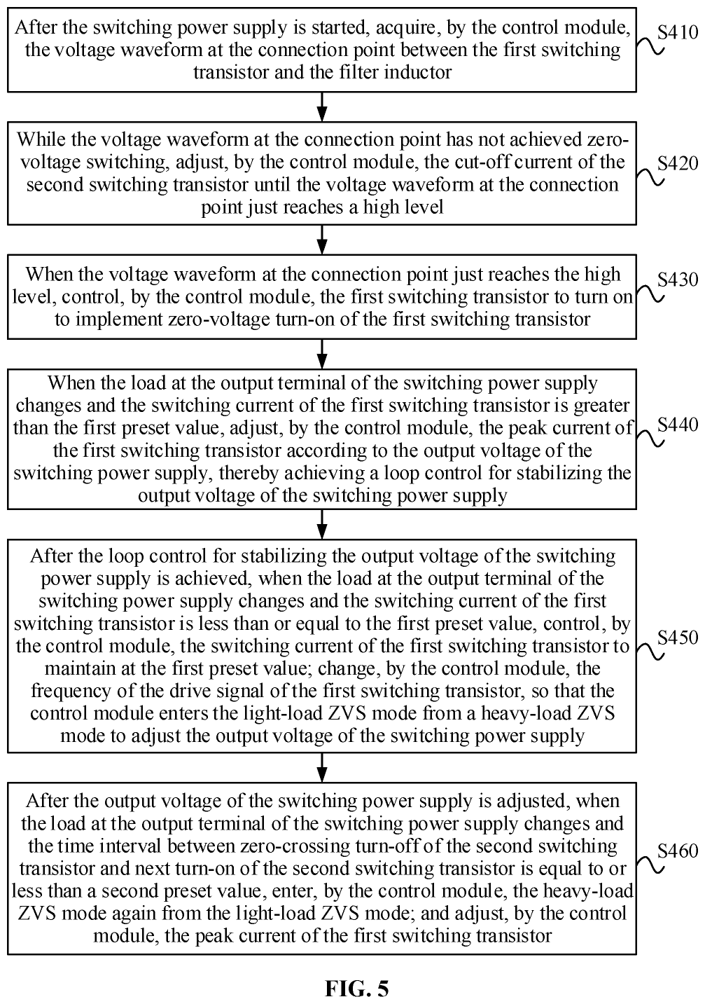

On the basis of the preceding embodiment, a control method for a switching power supply in the case, where the switching power supply is changed from the heavy load state to the light load state and then to the heavy load state again, is described below. However, this is not limited in this embodiment of the present application. With continued reference to FIG. 1, the switching power supply also includes an absorption circuit Q, which is connected in parallel to the two ends of the second switching transistor M2. The absorption circuit Q includes a first resistor R1 and a first capacitor C1 connected in series with each other. The voltage divider circuit E includes a second resistor R2 and a third resistor R3 connected in series with each other. FIG. 5 is a flowchart of another control method for a switching power supply according to an embodiment of the present application. As shown in FIG. 5, the control method for a switching power supply provided by this embodiment includes the steps below.

In S410, after the switching power supply is started, the control module acquires the voltage waveform at the connection point between the first switching transistor and the filter inductor.

In S420, while the voltage waveform at the connection point has not achieved zero-voltage switching, the control module adjusts the cut-off current of the second switching transistor until the voltage waveform at the connection point just reaches the high level.

In S430, when the voltage waveform at the connection point just reaches the high level, the control module controls the first switching transistor to turn on to achieve zero-voltage turn-on of the first switching transistor.

In S440, when the load at the output terminal of the switching power supply changes and the switching current of the first switching transistor is greater than the first preset value, the control module adjusts the peak current of the first switching transistor according to the output voltage of the switching power supply, thereby achieving a loop control for stabilizing the output voltage of the switching power supply.

In S450, after the loop control for stabilizing the output voltage of the switching power supply is achieved, when the load at the output terminal of the switching power supply changes and the switching current of the first switching transistor is less than or equal to the first preset value, the control module controls the switching current of the first switching transistor to maintain at the first preset value, changes the frequency of the drive signal of the first switching transistor, so that the control module enters the light-load ZVS mode from the heavy-load ZVS mode to adjust the output voltage of the switching power supply.

In S460, after the output voltage of the switching power supply is adjusted, when the load at the output terminal of the switching power supply changes and the time interval between zero-crossing turn-off of the second switching transistor and next turn-on of the second switching transistor is equal to or less than a second preset value, the control module enters the heavy-load ZVS mode again from the light-load ZVS mode and adjusts the peak current of the first switching transistor.

The fact that the load at the output terminal of the switching power supply changes, and the time interval between zero-crossing turn-off of the second switching transistor and next turn-on of the second switching transistor is equal to or less than the second preset value means that since the load at the output terminal changes, the time interval between zero-crossing turn-off of the second switching transistor M2 and next turn-on of the second switching transistor M2 is changed from being greater than the second preset value to being equal to or less than the second preset value so that the switching power supply is converted from the light load state to the heavy load state again. It is to be understood that in this case, the control module IC needs to repeat S420˜S440 to implement heavy-load ZVS adjustment.

In summary, on the basis that ZVS of the switching power supply in the heavy load state is achieved in the preceding embodiment, and the output voltage Vout of the switching power supply is maintained in the steady state, when the switching power supply changes from the heavy load state to the light load state, in this embodiment, the efficiency of the switching power supply in the light-load ZVS state can be optimized through frequency adjustment. In addition, when the switching power supply is converted from the light load state to the heavy load state again, in this embodiment, the heavy-load ZVS mode of the switching power supply can be achieved again by adjusting the peak current of the first switching transistor M1. Compared with the related technologies, the technical solutions of this embodiment can achieve the real-time conversion between a light-load ZVS frequency adjustment method and a heavy-load ZVS peak current adjustment method according to the load change at the output terminal of the switching power supply without increasing additional circuit costs and control complexity. In this manner, not only the switching loss of the switching power supply is reduced, but also the EMI characteristic of the switching power supply is improved.

With continued reference to FIG. 1, the switching power supply includes a first switching transistor M1, a second switching transistor M2, a filter inductor L, and a control module IC. The first switching transistor M1 is configured to be turned on or off according to a main drive signal Ig1 generated by the control module IC. The second switching transistor M2 is configured to be turned on or off according to a synchronous drive signal Ig2 generated by the control module IC. The filter inductor L is configured to smooth out the output current of the switching power supply.

The control module IC is configured to acquire the voltage waveform at the connection point SW between the first switching transistor M1 and the filter inductor L after the switching power supply is started. While the voltage waveform at the connection point SW has not achieved zero-voltage switching, the control module IC is also configured to adjust the cut-off current of the second switching transistor M2 until the voltage waveform at the connection point SW just reaches the high level. When the voltage waveform at the connection point SW just reaches the high level, the control module IC is further configured to control the first switching transistor M1 to turn on to achieve zero-voltage turn-on of the first switching transistor M1. When the load at the output terminal of the switching power supply changes, and the switching current of the first switching transistor M1 is greater than the first preset value, the control module IC is further configured to adjust the peak current of the first switching transistor M1 according to the output voltage Vout of the switching power supply, thereby achieving a loop control for stabilizing the output voltage Vout of the switching power supply. After the loop control for stabilizing the output voltage Vout of the switching power supply is achieved, when the load at the output terminal of the switching power supply changes and the switching current of the first switching transistor M1 is less than or equal to the first preset value, the control module is further configured to control the switching current of the first switching transistor M1 to maintain at the first preset value, change the frequency of the drive signal of the first switching transistor M1, and enter the light-load ZVS mode from a heavy-load ZVS mode to adjust the output voltage Vout of the switching power supply. After entering the light-load ZVS mode to adjust the output voltage of the switching power supply, when the load at the output terminal of the switching power supply changes, and the time interval between zero-crossing turn-off of the second switching transistor M2 and next turn-on of the second switching transistor M2 is equal to or less than the second preset value, the control module is further configured to enter the heavy-load ZVS mode again from the light-load ZVS mode and adjust the peak current of the first switching transistor M1.

For example, the first switching transistor M1 and the second switching transistor M2 may be, but are not limited to, metal-oxide-semiconductor field-effect transistors (MOSFETs). It is to be understood that the category selection and structure parameters of the first switching transistor M1 and the second switching transistor M2 are related to a desired power supply requirement to be achieved. This is not limited in this embodiment of the present application.

For example, after the switching power supply is started, when the peak value of the voltage waveform at the connection point SW approximately reaches the high level, the control module IC is further configured to control the first switching transistor M1 to turn on.

It is to be understood that after the switching power supply enters the light-load ZVS mode to adjust the output voltage of the switching power supply, when the load at the output terminal of the switching power supply changes and the time interval between zero-crossing turn-off of the second switching transistor and next turn-on of the second switching transistor is equal to or less than the second preset value, the switching power supply enters the heavy-load ZVS mode again from the light-load ZVS mode so as to adjust the peak current of the first switching transistor, which means that after the output voltage Vout of the switching power supply is adjusted, when the load at the output terminal of the switching power supply changes and the time interval between zero-crossing turn-off of the second switching transistor M2 and next turn-on of the second switching transistor M2 is changed from being greater than the second preset value to being equal to or less than the second preset value, the control module IC is further configured to enter the heavy-load ZVS mode again from the light-load ZVS mode and adjust the peak current of the first switching transistor M1.

Optionally, the switching power supply also includes the voltage divider circuit E configured to generate a voltage divider signal so that the control module IC acquires the output voltage Vout of the switching power supply.

Optionally, the voltage divider circuit E includes a second resistor R2 and a third resistor R3 connected in series with each other.

Optionally, the switching power supply also includes the absorption circuit Q. The absorption circuit Q includes a first resistor R1 and a first capacitor C1 connected in series with each other. The absorption circuit Q is configured to optimize a system switching loss, to reduce the voltage spike and/or the current spike of a switching transistor, and to improve the electromagnetic interference characteristics of the switching power supply.

It is to be noted that the first resistor R1, the second resistor R2, and the third resistor R3 may be any type of resistor. The types and parameters of the preceding resistors may be adaptively adjusted according to a desired power supply requirement achieved by the switching power supply. For example, the preceding resistors may be SMD resistors.

It is to be noted that the first capacitor C1 may be any type of capacitor. The type and parameter of the capacitor may be adaptively adjusted according to a desired power supply requirement achieved by the switching power supply. This is not limited in this embodiment of the present application. For example, the first capacitor C1 may be a mica capacitor.

In addition, the connection relationship of the circuit elements of the non-isolated switching power supply with a buck architecture provided in this embodiment of the present application is shown in FIG. 1, and the details are not repeated here. It is to be understood that Vin in FIG. 1 represents the input voltage of the switching power supply, and Iin represents the current flowing through the filter inductor.

With continued reference to FIG. 1, for example, the working process of the switching power supply is described below.

After the switching power supply is started, the control module IC acquires the voltage waveform at the connection point SW. When the voltage waveform at the connection point SW has not achieved zero-voltage switching, the control module IC adjusts the cut-off current of the second switching transistor M2 until the voltage waveform at the connection point SW just reaches the high level. When the voltage waveform at the connection point SW just reaches the high level, the control module IC controls the first switching transistor M1 to turn on to achieve zero-voltage turn-on of the first switching transistor M1. When the load at the output terminal of the switching power supply changes, and the switching current of the first switching transistor M1 is greater than the first preset value, the control module IC adjusts the peak current of the first switching transistor M1 according to the output voltage Vout of the switching power supply, thereby achieving a loop control for stabilizing the output voltage Vout of the switching power supply. After the loop control for stabilizing the output voltage Vout of the switching power supply is achieved, when the load at the output terminal of the switching power supply changes and the switching current of the first switching transistor M1 is less than or equal to the first preset value, the control module IC controls the switching current of the first switching transistor M1 to maintain near the first preset value based on the appropriate anti-jitter threshold value, changes the frequency of the drive signal of the first switching transistor M1, and enters the light-load ZVS mode from a heavy-load ZVS mode to adjust the output voltage Vout of the switching power supply. After entering the light-load ZVS mode to adjust the output voltage Vout of the switching power supply, when the load at the output terminal of the switching power supply changes and the time interval between zero-crossing turn-off of the second switching transistor M2 and next turn-on of the second switching transistor M2 is equal to or less than the second preset value, the control module IC enters the heavy-load ZVS mode again from the light-load ZVS mode and adjusts the peak current of the first switching transistor M1.

For example, in this embodiment of the present application, the control module IC may internally integrate a typical voltage reference module or may adopt an external voltage reference module, which enables the comparison between the output voltage Vout of the switching power supply and the module reference voltage provided by the voltage reference module, thereby achieving controllable adjustment of the output voltage Vout of the switching power supply under different conditions.

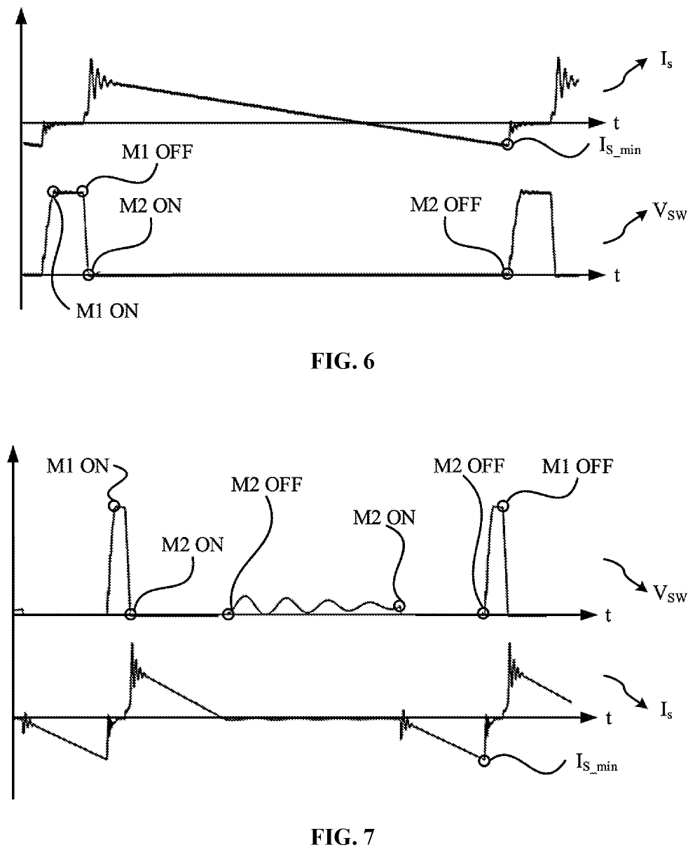

FIG. 6 is a waveform diagram of a switching power supply in a heavy-load ZVS mode according to an embodiment of the present application. With reference to the working process of the preceding switching power supply and FIG. 6, for example, when the waveform of the voltage V_{SW} at the connection point SW just reaches the high level, the first switching transistor M1 is turned on, and the second switching transistor M2 is in an off state. In addition, when the switching current I_{S} of the second switching transistor M2 reaches the cut-off current I_{S_min}, the second switching transistor M2 is turned off.

FIG. 7 is a waveform diagram of a switching power supply in a light-load ZVS mode according to an embodiment of the present application. With reference to the working process of the preceding switching power supply and FIG. 7, for example, in the light-load ZVS mode, the control module IC adjusts the frequency of the drive signal of the first switching transistor M1 or the time interval between turn-ons of the first switching transistor M1 or time interval between turn-offs of the first switching transistor M1 according to the voltage signal fed back by the voltage divider circuit E. When the frequency of the drive signal of M1 satisfies a preset value requirement or the time interval between turn-ons of the M1 or the time interval between turn-offs of the M1 satisfies a preset value requirement, the control module IC turns on the second switching transistor M2 and adjusts the cut-off current I_{S_min} of the second switching transistor M2, so that the voltage waveform at the connection point SW just reaches the high level. When the voltage waveform of SW just reaches the high level, the control module IC turns on the first switching transistor M1. When the switching current of the first switching transistor M1 reaches the first preset value, or the switching current of the first switching transistor M1 reaches near the first preset value based on a certain anti-jitter threshold value, the first switching transistor M1 is turned off, and the second switching transistor M2 is turned on. When the switching current I_{S} of the second switching transistor M2 is at a zero-crossing point, the second switching transistor M2 is turned off. Thus, this embodiment completes one period of the light-load ZVS mode and waits for the next moment when the frequency or the time interval between turn-ons of M1 or the time interval between turn-offs of M1 satisfies the requirements.

In this embodiment of the present application, on the basis that ZVS of the switching power supply in the heavy load state can be achieved, and the output voltage Vout of the switching power supply is maintained in the steady state, when the switching power supply changes from the heavy load state to the light load state, in this embodiment, the efficiency of the switching power supply in the light-load ZVS state can be optimized through frequency adjustment. In addition, when the switching power supply is converted from the light load state to the heavy load state again, in this embodiment, the heavy-load ZVS state is entered again.

Compared with the related technologies, the technical solutions of this embodiment can achieve the real-time switching between the light-load ZVS frequency adjustment method and the heavy-load ZVS peak current adjustment method according to the load change at the output terminal of the switching power supply without increasing additional circuit costs and control complexity. In this manner, not only the switching loss of the switching power supply is effectively reduced, but also the EMI characteristic of the switching power supply is improved.

It is to be noted that this embodiment of the present application may, but is not limited to, adjust the output voltage Vout of the switching power supply by using the light-load ZVS mode. For example, after the loop control for stabilizing the output voltage of the switching power supply is achieved, and when the load at the output terminal of the switching power supply changes, and the switching current of the first switching transistor M1 is less than or equal to the first preset value, the control module IC controls the switching current of the first switching transistor M1 to maintain at the first preset value. Moreover, a common non-zero voltage turn-on method is used. In the case where there is no procedure for the voltage waveform at the connection point SW to return to a high level, the frequency of the drive signal of the first switching transistor M1 is changed, so as to adjust the output voltage Vout of the switching power supply. For example, when the frequency of the drive signal of the first switching transistor M1 satisfies frequency requirement or the time interval between turn-ons of the first switching transistor M1 or the time interval between turn-offs of the first switching transistor M1 satisfies a time interval requirement, the control module IC turns on the first switching transistor M1. When the switching current of the first switching transistor M1 reaches the first preset value, or the switching current of the first switching transistor M1 reaches near the first preset value based on a certain preset anti-jitter threshold value, the first switching transistor M1 is turned off, and the second switching transistor M2 is turned on. When the switching current I_{S} of the second switching transistor M2 is at the zero-crossing point, the second switching transistor M2 is turned off. Thus, this embodiment implements one period of a light-load non-ZVS mode and waits for the next moment that the frequency or the time interval between turn-ons of M1 or the time interval between turn-offs of M1 satisfies requirements.

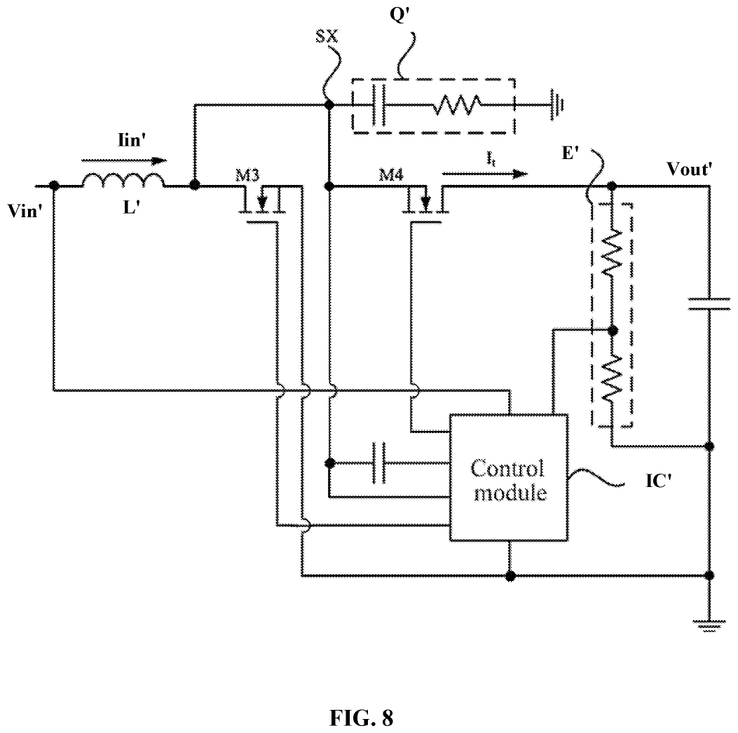

On the basis of the preceding embodiment, for example, FIG. 8 is a diagram illustrating the structure of another switching power supply according to an embodiment of the present application. For example, the switching power supply shown in FIG. 8 is a non-isolated synchronous switching power supply with a boost architecture. The connection relationship of the circuit elements of the switching power supply provided in this embodiment is shown in FIG. 8, and the details are not repeated here. It is to be understood that in FIG. 8, Vin′ represents the input voltage of the non-isolated synchronous switching power supply with the boost architecture. L′ represents the input inductor of the non-isolated synchronous switching power supply with the boost architecture. Iin′ represents the inductor current of the non-isolated synchronous switching power supply with the boost architecture. Q′ represents the absorption circuit of the non-isolated synchronous switching power supply with the boost architecture.

With continued reference to FIG. 8, for example, the working process of the non-isolated synchronous switching power supply of the boost architecture is described below.

After the switching power supply is started, the control module IC′ acquires the voltage waveform at the connection point SX. When the voltage waveform at the connection point SX does not implement zero-voltage switching, the control module IC′ adjusts the cut-off current of a fourth switching transistor M4 until the voltage waveform at the connection point SX approximately reaches the low level or just reaches the low level. When the voltage waveform at the connection point SX just reaches the low level, the control module IC′ controls a third switching transistor M3 to turn on. When the load at the output terminal of the switching power supply changes and the switching current of the third switching transistor M3 is greater than a third preset value, the control module IC′ adjusts the peak current of the third switching transistor M3 according to the output voltage Vout′ of the switching power supply, thereby achieving a loop control for stabilizing the output voltage Vout′ of the switching power supply. After the loop control for stabilizing the output voltage Vout′ of the switching power supply is implemented, when the load at the output terminal of the switching power supply changes and the switching current of the third switching transistor M3 is less than or equal to the third preset value, the control module IC′ controls the switching current of the third switching transistor M3 to maintain near the third preset value based on the appropriate anti-jitter threshold value, changes the frequency of a drive signal of the third switching transistor M3, and enters the light-load ZVS mode from the heavy-load ZVS mode to adjust the output voltage Vout′ of the switching power supply. After the light-load ZVS mode is entered to adjust the output voltage Vout′ of the switching power supply, when the load at the output terminal of the switching power supply changes, and the time interval between zero-crossing turn-off of the fourth switching transistor M4 and next turn-on of the fourth switching transistor M4 is equal to or less than a fourth preset value, the control module IC′ enters the heavy-load ZVS mode again from the light-load ZVS mode and adjusts the peak current of the third switching transistor M3.

It is to be understood that the voltage waveform at the connection point SX just reaches the low level, which means that the voltage waveform at the connection point SX just reaches the low-level state of a zero voltage. At this time, the voltage difference between the source of the third switching transistor M3 and the drain of the third switching transistor M3 is zero.

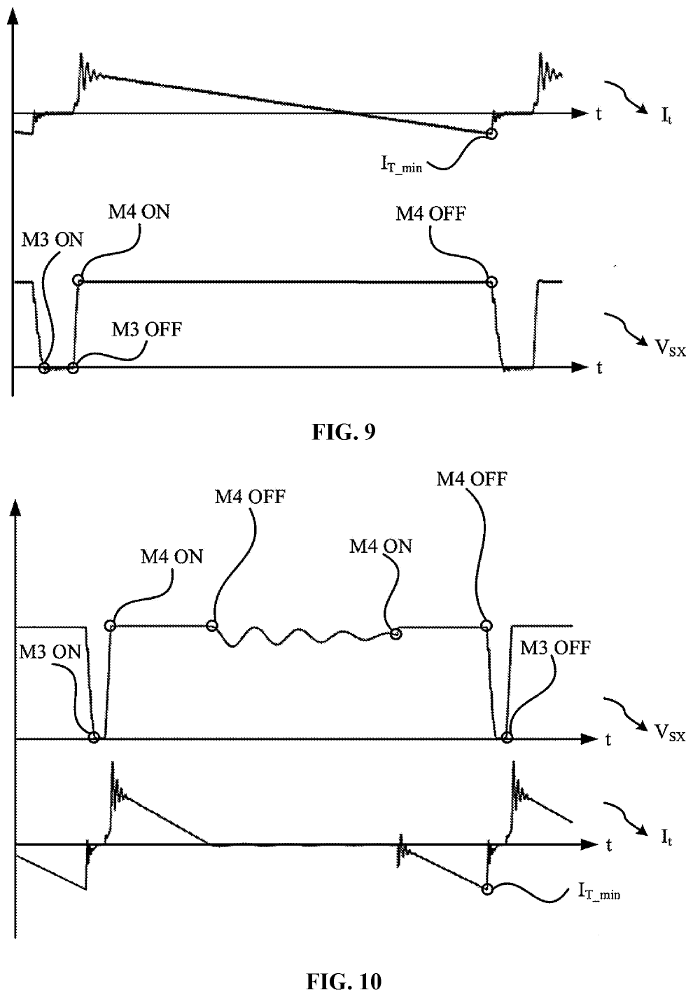

FIG. 9 is a waveform diagram of another switching power supply in a heavy-load ZVS mode according to an embodiment of the present application. With reference to the working process of the preceding non-isolated synchronous switching power supply with the boost architecture and FIG. 9, for example, when the waveform of the voltage V_{SX} at the connection point SX just reaches the low level, the third switching transistor M3 is turned on, and the fourth switching transistor M4 is in an off state. When the switching current Iₜ of the fourth switching transistor M4 reaches the cut-off current I_{T_min}, the fourth switching transistor M4 is turned off.

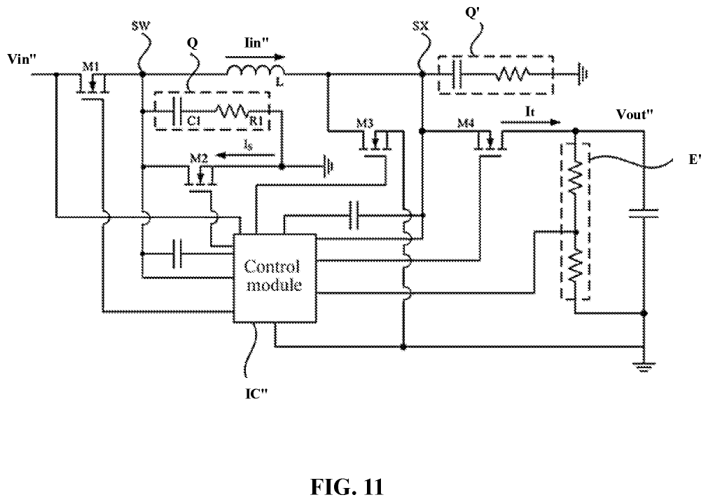

FIG. 10 is a waveform diagram of another switching power supply in a light-load ZVS mode according to an embodiment of the present application. With reference to the working process of the preceding non-isolated synchronous switching power supply with the boost architecture and FIG. 10, for example, in the light-load ZVS mode, the control module IC′ adjusts the frequency of the drive signal of the third switching transistor M3 or the time interval between turn-ons of the third switching transistor M3 or the time interval between turn-offs of the third switching transistor M3 according to the voltage signal fed back by the voltage divider circuit E′. When the frequency of the drive signal of M3 satisfies a requirement or the time interval between turn-ons of the M3 or the time interval between turn-offs of the M3 satisfies a requirement, the control module IC′ turns on the fourth switching transistor M4 and adjusts the cut-off current I_{T_min} of the fourth switching transistor M4 until the voltage waveform at the connection point SX just reaches the low level. When the voltage waveform of SX just reaches the low level, the control module IC′ turns on the third switching transistor M3. When the switching current of the third switching transistor M3 reaches the third preset value, or the switching current of the third switching transistor M3 reaches near the third preset value based on a certain preset anti-jitter threshold value, the third switching transistor M3 is turned off, and the fourth switching transistor M4 is turned on. Then, when the switching current Iₜ of the fourth switching transistor M4 is at a zero-crossing point, the fourth switching transistor M4 is turned off. Thus, this embodiment completes one period of the light-load ZVS mode and waits for the next moment when the frequency or the time intervals satisfy the requirements.

On the basis of the preceding embodiment, for example, FIG. 11 is a diagram illustrating the structure of another switching power supply according to an embodiment of the present application. For example, the switching power supply shown in FIG. 11 is a non-isolated synchronous switching power supply with a buck-boost architecture. The connection relationship of the circuit elements of the switching power supply provided in this embodiment is shown in FIG. 11, and the details are not repeated here. With reference to FIG. 11, Vin″ represents the input voltage of the non-isolated synchronous switching power supply with the buck-boost architecture. IC″ represents the control module of the non-isolated synchronous switching power supply with the buck-boost architecture. Iin″ represents the inductor current of the non-isolated synchronous switching power supply with the buck-boost architecture. Vout″ represents the output voltage of the non-isolated synchronous switching power supply with the buck-boost architecture.

Iₜ is to be understood that the non-isolated synchronous switching power supply with the buck-boost architecture may be formed by connecting part of the circuit structures of the non-isolated synchronous switching power supply with the boost architecture and non-isolated synchronous switching power supply with the buck architecture. The non-isolated synchronous switching power supply with the buck-boost architecture includes a boost mode, a buck mode, and a buck-boost mode. Iₜ is to be understood that the node waveform diagrams corresponding to the boost mode and the buck mode may be composed of multiple waveform diagrams of the preceding non-isolated synchronous switching power supply with the boost architecture and non-isolated synchronous switching power supply with the buck architecture and appear on the nodes of the boost architecture or the buck architecture. The buck-boost mode may be a composite mode of the boost mode and buck mode. When the switching power supply is in the buck-boost mode, waveforms on the nodes of the boost architecture and buck architecture may appear simultaneously or alternately. This is not limited in this embodiment of the present application. The composite mode of the boost mode and buck mode described herein means that in the non-isolated synchronous switching power supply with the buck-boost architecture, the non-isolated synchronous switching power supply part of the boost architecture and the non-isolated synchronous switching power supply part of the buck architecture are in a working state simultaneously or alternately. The boost mode means that in the non-isolated synchronous switching power supply with the buck-boost architecture, the boost architecture part of the non-isolated synchronous switching power supply is in a working state, and the buck architecture part of the non-isolated synchronous switching power supply is in a state without alternating switching. The buck mode means that in the non-isolated synchronous switching power supply with the buck-boost architecture, the boost architecture part of the non-isolated synchronous switching power supply is in a state without alternating switching, and the buck architecture part of the non-isolated synchronous switching power supply is in a working state.

Iₜ is to be noted that when the non-isolated synchronous switching power supply of the buck-boost architecture is in the boost mode, the first switching transistor M1 is in a real-time on state, and the second switching transistor M2 is in a real-time off state. On the contrary, when the non-isolated synchronous switching power supply with the buck-boost architecture is in the buck mode, the fourth switching transistor M4 is in a real-time on state, and the third switching transistor M3 is in a real-time off state.

What is claimed is:

1. A control method for a switching power supply, wherein the switching power supply comprises a first switching transistor, a second switching transistor, a filter inductor, and a control module, wherein the first switching transistor is connected between a voltage input terminal and the filter inductor, the second switching transistor is connected between the first switching transistor and a ground terminal, the filter inductor is connected between the first switching transistor and a voltage output terminal of the switching power supply, and the control module is configured to control the first switching transistor and the second switching transistor to turn on or turn off, and
wherein the control method comprises:
after the switching power supply is started, the control module acquires a voltage waveform at a connection point between the first switching transistor and the filter inductor;
in response to the voltage waveform at the connection point not achieving zero-voltage switching, the control module adjusts a cut-off current of the second switching transistor until the voltage waveform at the connection point just reaches a high level; and
in response to the voltage waveform at the connection point just reaching the high level, the control module controls the first switching transistor to turn on to achieve zero-voltage turn-on of the first switching transistor.

2. The method according to claim 1, wherein the switching power supply further comprises a voltage divider circuit, wherein the voltage divider circuit is connected between the filter inductor and an output voltage detection terminal of the control module; and
the method further comprises:
in response to a load at an output terminal of the switching power supply changing and a switching current of the first switching transistor being greater than a first preset value, the control module adjusts a peak current of the first switching transistor according to an output voltage of the switching power supply to achieve a loop control for stabilizing the output voltage of the switching power supply, and the control module enters a heavy-load zero-voltage switching (ZVS) mode.

3. The method according to claim 2, after implementing the loop control for stabilizing the output voltage of the switching power supply, the method further comprising:
in response to the load at the output terminal of the switching power supply changing and the switching current of the first switching transistor being less than or equal to the first preset value, the control module controls the switching current of the first switching transistor to maintain at the first preset value, changes a frequency of a drive signal of the first switching transistor, and the control module enters a light-load ZVS mode from the heavy-load ZVS mode to adjust the output voltage of the switching power supply.

4. The method according to claim 3, after entering the light-load ZVS mode to adjust the output voltage of the switching power supply, the method further comprising:
in response to the load at the output terminal of the switching power supply changing, and a time interval between zero-crossing turn-off of the second switching transistor and next turn-on of the second switching transistor being equal to or less than a second preset value, the control module enters the heavy-load ZVS mode again from the light-load ZVS mode and adjusts the peak current of the first switching transistor.

5. The method according to claim 1, wherein the switching power supply further comprises an absorption circuit connected in parallel to two ends of the second switching transistor; and the absorption circuit comprises a first resistor and a first capacitor connected in series with each other.

6. The method according to claim 2, wherein the voltage divider circuit comprises a second resistor and a third resistor connected in series with each other.

7. A switching power supply, comprising a first switching transistor, a second switching transistor, a filter inductor, and a control module, wherein
the first switching transistor is configured to be turned on or off according to a main drive signal generated by the control module;
the second switching transistor is configured to be turned on or off according to a synchronous drive signal generated by the control module;
the filter inductor is configured to smooth out an output current of the switching power supply; and
the control module is configured to acquire a voltage waveform at a connection point between the first switching transistor and the filter inductor after the switching power supply is started; when the voltage waveform at the connection point has not achieved zero-voltage switching, the control module is further configured to adjust a cut-off current of the second switching transistor until the voltage waveform at the connection point just reaches a high level; when the voltage waveform at the connection point just reaches the high level, the control module is further configured to control the first switching transistor to turn on to achieve zero-voltage turn-on of the first switching transistor; when a load at an output terminal of the switching power supply changes, and a switching current of the first switching transistor is greater than a first preset value, the control module is further configured to adjust a peak current of the first switching transistor according to an output voltage of the switching power supply to achieve a loop control for stabilizing the output voltage of the switching power supply; after the loop control for stabilizing the output voltage of the switching power supply is implemented, when the load at the output terminal of the switching power supply changes and the switching current of the first switching transistor is less than or equal to the first preset value, the control module is further configured to control the switching current of the first switching transistor to maintain at the first preset value, change a frequency of a drive signal of the first switching transistor, and enter a light-load ZVS mode from a heavy-load ZVS mode to adjust the output voltage of the switching power supply; and after the light-load ZVS mode is entered to adjust the output voltage of the switching power supply, when the load at the output terminal of the switching power supply changes and a time interval between zero-crossing turn-off of the second switching transistor and next turn-on of the second switching transistor is equal to or less than a second preset value, the control module is further configured to enter the heavy-load ZVS mode again from the light-load ZVS mode and adjust the peak current of the first switching transistor.

8. The switching power supply according to claim 7, further comprising a voltage divider circuit configured to generate a voltage divider signal so that the control module acquires the output voltage of the switching power supply.

9. The switching power supply according to claim 7, further comprising an absorption circuit, wherein the absorption circuit comprises a first resistor and a first capacitor connected in series with each other; and the absorption circuit is configured to optimize a system switching loss, reduce at least one of a voltage spike or a current spike of a switching transistor.

10. The switching power supply according to claim 8, wherein the voltage divider circuit comprises a second resistor and a third resistor connected in series with each other.

11. The method according to claim 2, wherein the switching power supply further comprises an absorption circuit connected in parallel to two ends of the second switching transistor; and the absorption circuit comprises a first resistor and a first capacitor connected in series with each other.

12. The method according to claim 3, wherein the switching power supply further comprises an absorption circuit connected in parallel to two ends of the second switching transistor; and the absorption circuit comprises a first resistor and a first capacitor connected in series with each other.

13. The method according to claim 4, wherein the switching power supply further comprises an absorption circuit connected in parallel to two ends of the second switching transistor; and the absorption circuit comprises a first resistor and a first capacitor connected in series with each other.

14. The method according to claim 3, wherein the voltage divider circuit comprises a second resistor and a third resistor connected in series with each other.

15. The method according to claim 4, wherein the voltage divider circuit comprises a second resistor and a third resistor connected in series with each other.

16. The method according to claim 5, wherein the voltage divider circuit comprises a second resistor and a third resistor connected in series with each other.

17. The switching power supply according to claim 8, further comprising an absorption circuit, wherein the absorption circuit comprises a first resistor and a first capacitor connected in series with each other; and the absorption circuit is configured to optimize a system switching loss, reduce at least one of a voltage spike or a current spike of a switching transistor.

18. The switching power supply according to claim 9, wherein the voltage divider circuit comprises a second resistor and a third resistor connected in series with each other.
